(19) United States
(12) Patent Application Publication
(10) Pub. No.: US 2005/0274667 A1
(43) Pub. Date: Dec. 15, 2005

(54) Method for manufacturing filtering baskets of fibres in aqueous suspension and a filtering basket manufactured with said method

(76) Inventors: Giancarlo Dal Maso, Schio (VI) (IT); Flavio Magaraggia, Vicenza (IT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/994,405

(22) Filed: Nov. 23, 2004

(30) Foreign Application Priority Data
Jun. 10, 2004 (IT) VI2004A000139

(51) Int. Cl. B01D 29/085

(52) U.S. Cl. 210/497.01; 210/488; 210/487

(57) ABSTRACT

A method for manufacturing filtering baskets for filtering machines of fibres in aqueous suspension by preparing a plurality of mainly longitudinal developed shaped bars and the step in which the shaped bars are disposed side by side one close to another, at least some of the shaped bars having the contact surfaces with the adjacent shaped bars belonging to mutually convergent planes, to define a tubular structure having a central longitudinal axis. The method further includes the step of externally encircling the shaped bars by two or more coaxial annular members along the longitudinal axis (X).

### BACKGROUND OF THE INVENTION

The invention is about a method for manufacturing filtering baskets for filtering machines of fibres in aqueous suspension.

The invention is about as well a filtering basket obtained according to the teachings of said method.

It is known that, in paper manufacture, the aqueous suspensions containing cellulose fibres have to be properly filtered to separate any present impurities therefrom before being used in the productive process.

The filtering is performed through mechanical refiners, inside which the aqueous suspension is separated from the impurities and the pollutant substances contained therein to be sent to the subsequent processing.

All the mechanical refiners belonging to the prior art, although in their different specific embodiments, substantially consist of a fixed filtering basket having its side surface provided with calibrated openings, in which a rotor is internally disposed, with the function of maintaining the suspension mixed enough to avoid the stoppage of the calibrated openings caused by the unfiltered material.

The fixed filtering basket has its side surface consisting of a plate provided with a plurality of holes or, alternatively, with a plurality of notches generally disposed according to the longitudinal axis of said basket.

According to other more modern known embodiments, the baskets consist of a plurality of mainly longitudinal developed metal bars, having a substantially trapezoidal cross sectional shape and disposed according to a cylindrical surface.

In particular, the bars are mutually parallel disposed side by side and they are supported by a plurality of mutually coaxial and spaced annular elements, to which they are fixed at the inner circumference.

The filtering surface thus defined consists of the plurality of slots formed by the mutually adjacent bars.

In such a way, filtering baskets of greater efficiency are obtained because they have a greater useful filtering surface, being equal the overall side surface, with respect to the embodiments of known type.

The bars and the annular elements are generally made of stainless steel and the bars are mutually disposed side by side, in proper seats obtained in the annular elements supporting them.

The fixing of the bars to the annular elements is performed by welding or, according to other embodiments, by direct clinching or by the interposition of support elements.

In further embodiments, the rings can be made of carbon fibre and the bars are fixed to the seats through adhesive substances.

Filtering baskets having the aforementioned characteristics are disclosed in the documents WO03091496, U.S. Pat. No. 6,131,743 and WO03102297.

However, the cited known filtering baskets have some acknowledged inconveniences.

A first inconvenience is due to the constructional complexity coming from the need to arrange, on each support annular element, the proper seats for housing the bars and subsequently for performing their fixing by welding, adhesive substances or clinching.

Another inconvenience is due to the difficulty to maintain constant, with reduced tolerance, the distance between adjacent bars, both during manufacture and when the manufacture is completed, in order to maintain constant the width of the slots for the entire basket length.

The achievable tolerance is defined by the sum of the manufacturing tolerances of the seats in the support annular elements, the deformations due to the clinching or the welding of the shaped bars and the shape constancy of said bars.

In particular recent embodiments, where the size of the slots is close to the size of the fibres to be treated, this tolerance becomes extremely important for a good efficiency of the filtering process.

A further inconvenience is due to the fact that vibrations occur during operation, frequently causing breakings due to fatigue.

In fact, such breakings occur in the clinching or welding points of the bars to the support annular elements, where the concentration of tensions is a starting point of possible fatigue breakings.

Another inconvenience is due to the fact that the number of bars, and consequently of filtering slots, which can be provided in the cited known baskets is limited by the minimum thickness that each bar must have to be welded, glued or clinched in the seat obtained on the annular elements, which evidently cannot have a high density not to compromise the mechanical resistance of the annular element.

The present invention intends to overcome the aforementioned inconveniences.

### SUMMARY OF THE INVENTION

It is a first object of the invention to provide for a filtering basket for filtering machines of fibres in aqueous suspension which simplifies the known constructional technique, reducing the number of machining operations, the number of components and consequently the productive costs.

It is another object of the invention to provide for a filtering basket in which it is possible to obtain a greater filtering surface with respect to the cited prior art.

It is a further object of the invention to provide for a filtering basket which is more fatigue-resistant and consequently of higher durability with respect to the cited known baskets.

Said objects are obtained by providing for a method for manufacturing filtering baskets for filtering machines of fibres in aqueous suspension which, according to the main claim, is characterized by comprising the following steps:
preparing a plurality of mainly longitudinal developed shaped bars;
disposing said shaped bars side by side one close to another, at least some of said shaped bars having the contact surfaces with the adjacent shaped bars belonging to mutually convergent planes, to define a tubular structure having a central longitudinal axis;
externally encircling said shaped bars by means of two or more mutually coaxial according to said longitudinal axis and mutually spaced annular elements.

The filtering basket, being too object of the invention, carried out according to the method hereby described, is characterized by comprising:
a plurality of mainly longitudinal developed shaped bars disposed side by side one close to another, at least some of said shaped bars having the contact surfaces with the adjacent shaped bars belonging to mutually convergent planes, to define a tubular structure having a central longitudinal axis;
two or more mutually coaxial annular elements, mutually spaced according to said longitudinal axis, externally coupled with said shaped bars with radial interference to provide for the encircling of said shaped bars.

Preferably, according to the invention, the longitudinal axis of the basket is parallel to the directions defined by the shaped bars, so that the basket takes a tubular cylindrical shape in which the shaped bars form the side surface and the longitudinal directions defined by the shaped bars form as many generatrixes therein.

Advantageously, the use of shaped bars disposed side by side and encircled by means of the annular elements simplifies the constructional technique of the baskets and reduces their productive costs.

In fact, the machining operations of discs engraving, of any bars treatment and of fixing by welding, gluing or other are avoided.

More advantageously, the use of shaped bars disposed side by side allows to increase the filtering surface, being equal the side surface of the basket, with a consequent higher efficiency of the aqueous suspension filtering process.

Still advantageously, being the bars mutually coupled in an integral way, the tolerance which can be obtained at the slots is exclusively connected to possible imperfections of the shaped bars profile.

### BRIEF DESCRIPTION OF THE DRAWINGS

The aforesaid objects and advantages will be better highlighted in the description of preferred embodiments of the invention, given in an explanatory but not limiting way, with reference to the figures of the annexed drawings, wherein:

FIG. 1 is an axonometric view of the filtering basket of the invention;

FIG. 2 shows a detail of the filtering basket of FIG. 1;

FIGS. 3 and 4 show the different assembling stages of the basket of FIG. 1;

FIG. 5 is a sectional view of the detail shown in FIG. 4;

FIG. 6 shows another executive embodiment of the basket of FIG. 1;

FIGS. 7 and 8 show the different assembling stages of the basket of FIG. 6; and

FIG. 9 is a sectional view of the detail shown in FIG. 8.

### DESCRIPTION OF THE INVENTION

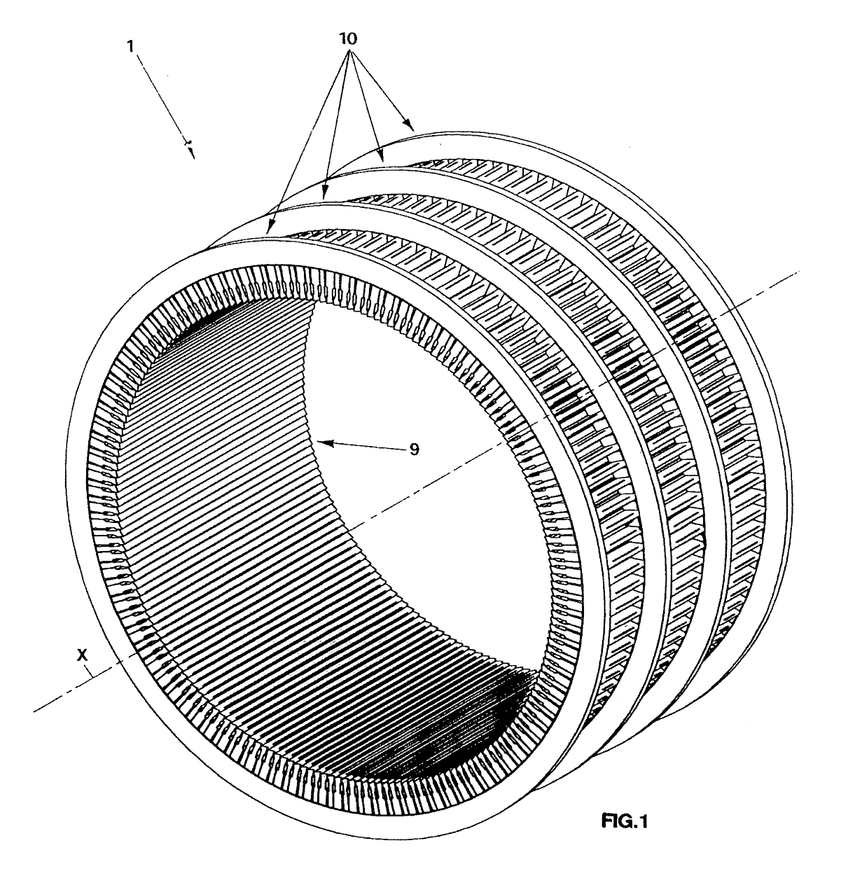

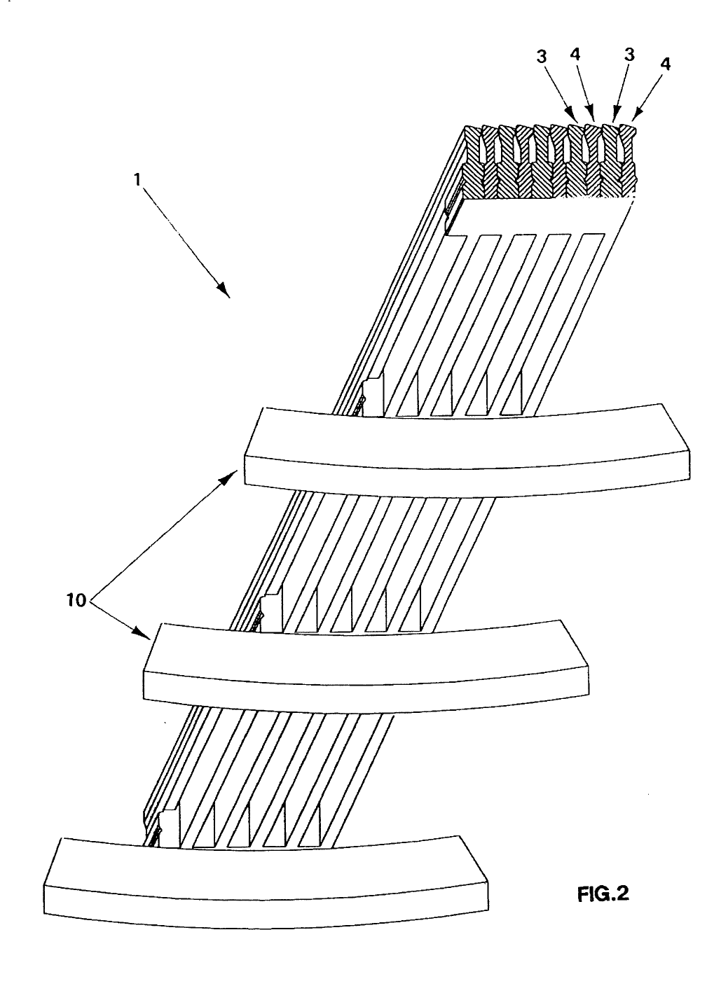

The filtering basket of the invention is shown in FIGS. 1 and 2, where it is generally indicated with numeral 1.

It is applied to machines for filtering fibres in aqueous suspension and, according to the invention, it comprises a plurality of mainly longitudinally developed shaped bars 3, 4 disposed side by side one close to another.

The shaped bars 3, 4 have the contact surfaces 5, 6, 7, 8 with the adjacent shaped bars 3, 4 belonging to mutually convergent planes to define, once disposed side by side, a tubular structure 9 having a central longitudinal axis X substantially parallel to the longitudinal directions defined by the shaped bars 3, 4.

The filtering basket 1 further comprises two or more mutually coaxial and mutually spaced according to the longitudinal axis X annular elements 10, externally coupled with the shaped bars 3, 4.

The annular elements 10 are coupled with radial interference to provide for encircling the shaped bars 3, 4 and to stably constrain the tubular structure 9 defined therefrom.

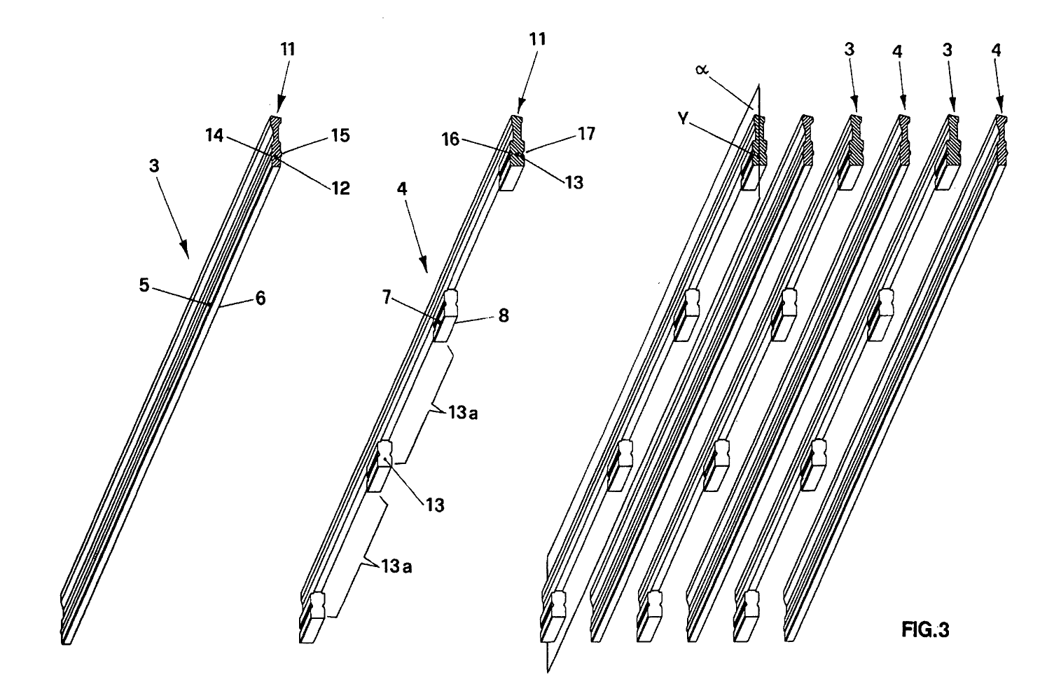

As one can see in FIG. 3, the shaped bars 3, 4 comprise a substantially trapezoidal shaped head 11, with the longer base 11a turned toward the interior of the basket 1 and a substantially parallelepipedal shaped body 12, 13 of reciprocal bearing.

The coupling of the bearing surfaces 5, 6, 7, 8 of each shaped bar 3, 4 with the adjacent ones is made stable by the presence of mutually joinable concavities 16, 17 and insertion protuberances 14, 15, provided on the body 12, 13 of each shaped bar 3, 4.

The embodiment of FIG. 3 comprises a first 3 and a second 4 series of shaped bars, which are alternately disposed side by side to provide for the tubular structure 9.

In particular, all the shaped bars 3 comprise a continuous body 12, of substantially symmetrical shape with respect to the longitudinal plane α passing through the longitudinal axis Y defined by the shaped bar 3, on which protuberances 14, 15 for the insertion in corresponding concavities 16, 17 made on the body 13 of the shaped bars 4 are obtained, said body 13 being of symmetrical shape too but having missing portions 13a.

The missing portions 13a are such to define C shaped recesses disposed along the longitudinal axis Y, with constant pitch, on the body 13 of the shaped bars 4.

In such a way, when the shaped bars 3, 4 are mutually disposed side by side, the presence of missing portions 13a on the body 13 of the shaped bars 4 defines a drainage chamber 18 from which the filtered suspension exits.

According to this embodiment, the width of the body 12, 13 is greater than the width of the longer base 11a of the head 11, which is disposed centred with respect to the longitudinal plane α to define a plurality of slots 19 able to provide for the filtering surface of the basket 1.

The executive embodiment 100, shown in FIGS. from 6 to 9, differs from the previously described one in that the all shaped bars 20 are equal and they all have portions 21a recessed in the body 21 at the side surface turned toward the adjacent shaped bar 20.

The body 21 of each shaped bar 20 is provided with concavities 23 on one contact surface 25 and with insertion protuberances 22 on the other contact surface 24, joinable one to another, able to allow the coupling to define the tubular structure.

The head 26 of the shaped bar 20, of substantially trapezoidal shape, is disposed in an eccentric position with respect to the longitudinal symmetry plane β of the bar 20, where the width of the longer base 26a is lower than the width of the body 21, to define a plurality of slots 27 which provide for the filtering surface of the basket 100 when the shaped bars 20 are disposed side by side.

In both the described embodiments 1, 100 the missing portions 13a and the recessed portions 21a are comprised between two adjacent annular elements 10.

In order to provide for filtering baskets having different diameters, some shaped bars have contact surfaces belonging to mutually convergent planes, with an angle being a function of the basket final diameter.

Concerning the heads 11, 26 of the shaped bars 3, 4, 20, they all have the same shape and size in all the described and shown executive embodiments 1, 100.

In the filtering basket of the invention, according to the teachings of the international published application WO03102297, filed by the same applicant of the present invention, the heads of the shaped bars could be disposed at not constant radial distances with respect to the longitudinal axis of the tubular structure.

In particular, the shaped bars comprise first shaped bars and second shaped bars, where the heads of the first shaped bars and the second shaped bars are disposed according to circumferences coaxial with the tubular structure longitudinal axis and they have different radiuses.

The heads of the first and second shaped bars are disposed according to a first and a second circumference, where the first circumference has a lower radius with respect to the second circumference radius.

The surface turned toward the interior of the basket of each of the first shaped bars head is orthogonally disposed with respect to the first circumference radius, while the surface turned toward the interior of the basket of each of the second shaped bars head is inclined with respect to the second circumference radius.

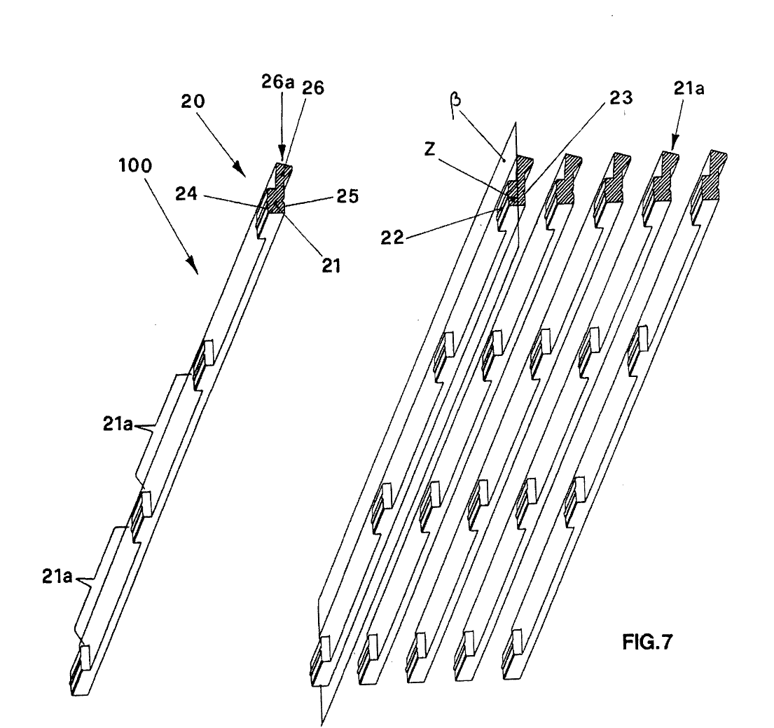

Operatively, to proceed for coupling and manufacturing the filtering basket 1, 100, the shaped bars 3, 4, 20 have to be disposed side by side, as shown in FIGS. 3 and 7.

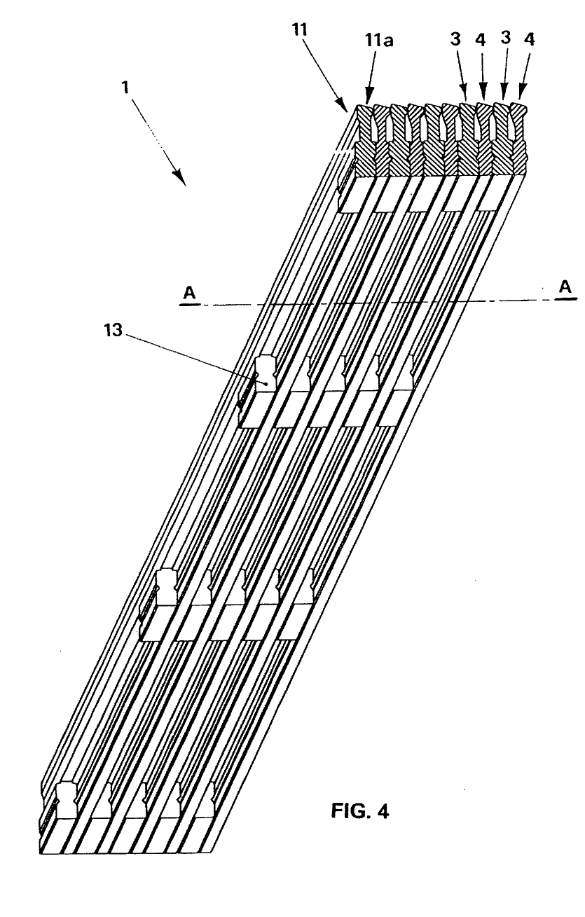

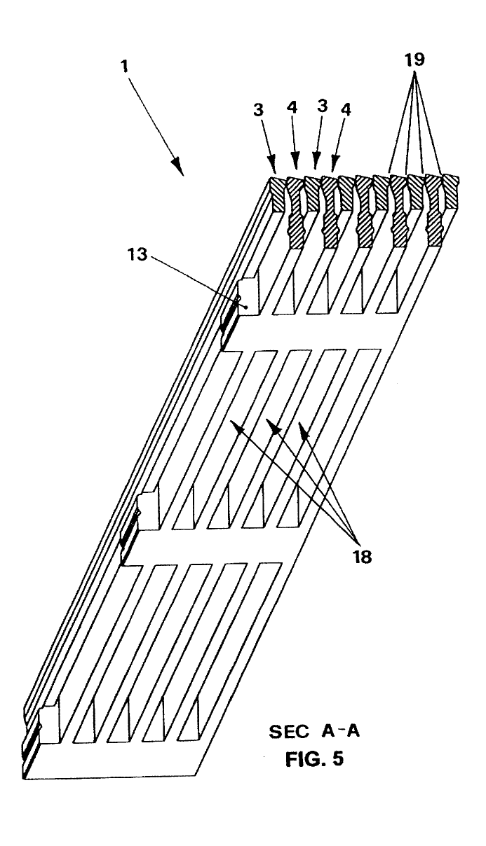

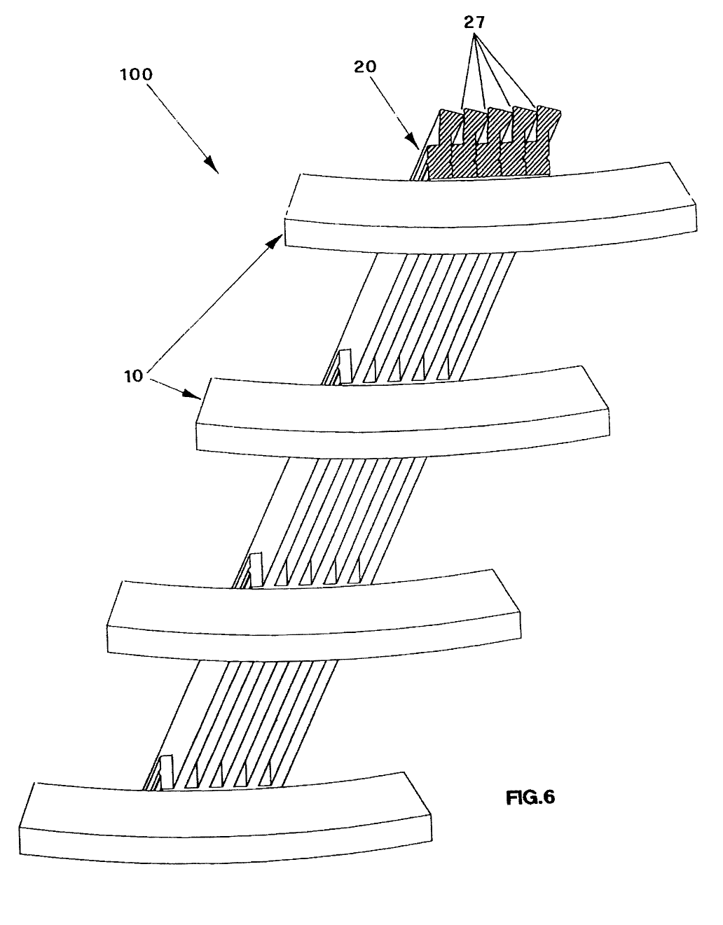

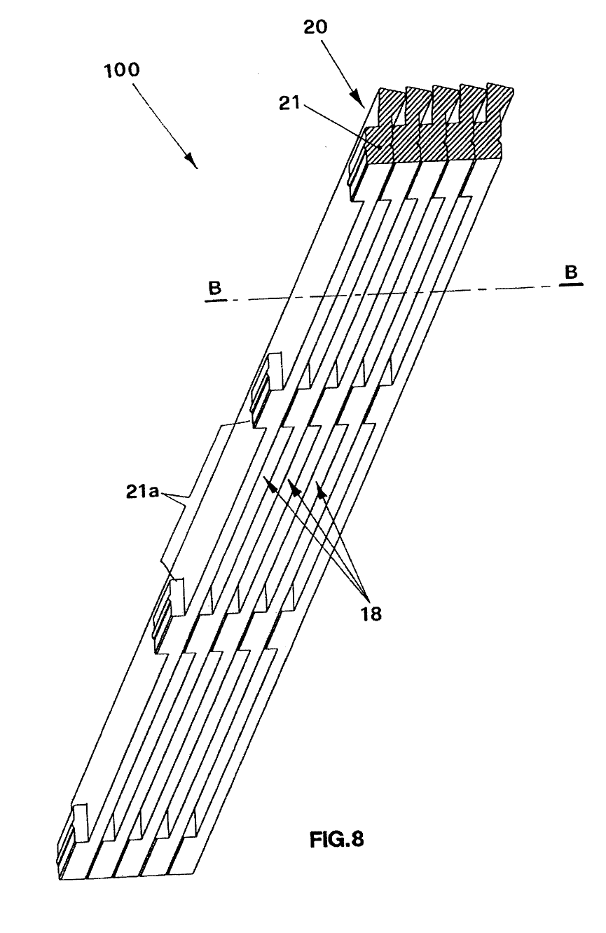

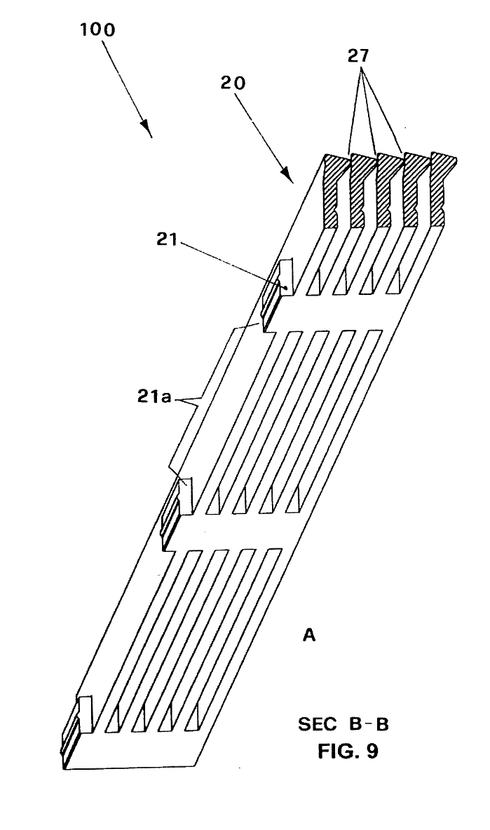

The shaped bars 3, 4, 20 are disposed side by side with the contact surfaces 5, 6, 24, 25, so that the joined profiles 14, 15, 16, 17, 22, 23 consisting of the concavities 16, 17, 23 and the insertion protuberances 14, 15, 22 present on the bodies 12, 13, 21 are coupled, as shown in FIGS. 4 and 8, to form the tubular structure 9.

At this point, the annular elements 10 are externally coupled, with radial interference, with the tubular structure 9 to obtain the encircling of the shaped bars 3, 4, 20 and to give stability and stiffness to the filtering basket 1, 100.

On the basis of the aforesaid description, it should be understood that the filtering basket 1, 100 of the invention, in all the described embodiments, achieves all the intended objects.

In particular, it is achieved the object to provide for a filtering basket for filtering machines of fibres in aqueous suspension which simplifies the known constructional technique and reduces its productive costs.

In fact, the machining operations of discs engraving, of any bars treatment and of fixing by welding, gluing or other are avoided.

It is achieved the object to provide for a filtering basket in which it is possible to obtain a greater filtering surface with respect to the cited prior art, being equal the side surface of the basket, with a consequent higher efficiency of the aqueous suspension filtering process.

It is achieved the object to provide for a filtering basket which is more fatigue-resistant and consequently of higher durability with respect to the cited known baskets.

It is finally achieved the object to obtain a reduced size tolerance of the filtering basket slots.

Modifications and variations to the filtering basket of the invention, not described and not shown in the drawings, could be introduced in the executive stage.

All the described and any other not cited embodiments, if they fall within the scope of protection of the following claims, should be intended as protected by the present patent.

1. A method for manufacturing filtering baskets for filtering machines of fibres in aqueous suspension, wherein it comprises the following steps:
preparing a plurality of mainly longitudinal developed shaped bars;
disposing said shaped bars side by side one close to another, at least some of said shaped bars having the contact surfaces with the adjacent shaped bars belonging to mutually convergent planes, to define a tubular structure having a central longitudinal axis;
externally encircling said shaped bars by means of two or more mutually coaxial according to said longitudinal axis and mutually spaced annular elements.

2. The method according to claim 1, wherein said shaped bars form longitudinal directions, parallel one to another and to said central longitudinal axis.

3. A filtering basket for filtering machines of fibres in aqueous suspension, wherein it comprises:
a plurality of mainly longitudinal developed shaped bars disposed side by side one close to another, at least some of said shaped bars having the contact surfaces with the adjacent shaped bars belonging to mutually convergent planes, to define a tubular structure having a central longitudinal axis;
two or more mutually coaxial annular elements, mutually spaced according to said longitudinal axis, externally coupled with said shaped bars with radial interference to provide for the encircling of said shaped bars.

4. The filtering basket according to claim 3, wherein said mutually convergent planes, to which said contact surfaces belong, converge in said central longitudinal axis.

5. The filtering basket according to claim 3, wherein said contact surfaces of said shaped bars comprise mutually joinable concavities and insertion protuberances able to mutually stably constrain said shaped bars when they are encircled by means of said annular elements.

6. The filtering basket according to claim 1, wherein the cross sectional profile of each of said shaped bars comprises a substantially trapezoidal shaped head with the longer base turned toward the interior of said basket and a substantially parallelepipedal shaped body of reciprocal bearing.

7. The filtering basket according to claim 6, wherein the width of said body is greater than the width of said longer base of said head, to define a plurality of slots between said bars able to provide for the filtering surface of said basket.

8. The filtering basket according to claim 6, wherein said body has a substantially symmetrical shape with respect to a longitudinal plane passing through the longitudinal axis defined by said shaped bar.

9. The filtering basket according to claim 8, wherein said head is centred with respect to said longitudinal plane.

10. The filtering basket according to claim 8, wherein said head is eccentric with respect to said longitudinal plane.

11. The filtering basket according to claim 6, wherein said shaped bars comprise a first series of shaped bars, with constant section along the longitudinal axis thereby defined, and a second series of shaped bars, each of them having missing portions in the body able to define C shaped recesses, each bar of said first series being disposed side by side with a bar belonging to said second series.

12. The filtering basket according to claim 11, wherein said C shaped recesses are disposed along the longitudinal axis of said shaped bars, with constant pitch.

13. The filtering basket according to claim 11, wherein said missing portions are comprised between two of said adjacent annular elements.

14. The filtering basket according to claim 6, wherein said body of said shaped bar has recessed portions at a side surface turned toward the adjacent shaped bar.

15. The filtering basket according to claim 14, wherein said recessed portions are comprised between two of said adjacent annular elements.

16. The filtering basket according to claim 6, wherein said heads of said shaped bars are disposed at not constant radial distances with respect to said longitudinal axis of said tubular structure, said shaped bars comprising first shaped bars and second shaped bars where the heads of said first shaped bars and said second shaped bars are disposed according to circumferences coaxial with said tubular structure longitudinal axis and they have different radiuses.

17. The filtering basket according to claim 16, wherein said heads of said first shaped bars are all disposed according to a first circumference and said heads of said second shaped bars are all disposed according to a second circumference, said first circumference having a lower radius with respect to said second circumference radius.

18. The filtering basket according to claim 17, wherein said head of each of said first shaped bars has the surface turned toward the interior of said basket which is orthogonally disposed with respect to the first circumference radius, and said head of each of said second shaped bars has the surface turned toward the interior of said basket which is inclined with respect to said second circumference radius.

19. The filtering basket according to what substantially described and shown.
